(19) United States
(12) Patent Application Publication
(10) Pub. No.: US 2026/0244468 A1
(43) Pub. Date: Aug. 20, 2026

(54) ADAPTIVE CURSOR OR TOOLTIP MANAGEMENT

(71) Applicant: Capital One Services, LLC, McLean, VA (US)

(72) Inventor: Bryan TAMAYO, Allen, TX (US)

(21) Appl. No.: 19/058,426

(22) Filed: Feb. 20, 2025

(51) Int. Cl. G06F 9/451; G06F 3/04812

(52) U.S. Cl. CPC G06F 9/453; G06F 3/04812

(57) ABSTRACT

In some implementations, an adaptive cursor or tooltip management system may receive first user interaction information associated with a first user device indicating a user interaction with a first web page. The adaptive cursor or tooltip management system may receive first user context information that indicates user data associated with the first user device. The adaptive cursor or tooltip management system may identify, based on the first user interaction information and the first user context information, one or more of first cursor display information or first tooltip display information. The adaptive cursor or tooltip management system may transmit the one or more of the first cursor display information or the first tooltip display information. The adaptive cursor or tooltip management system may receive user feedback information associated with the one or more of the first cursor display information or the first tooltip display information.

### BACKGROUND

Traditional mouse cursors allow users to interact with online platforms by performing pointing and selection. Such cursors often have static designs.

### SUMMARY

Some implementations described herein relate to a system for adaptive cursor or tooltip management. The system may include one or more memories and one or more processors communicatively coupled to the one or more memories. The one or more processors may be configured to receive first user interaction information associated with a first user device indicating a user interaction with a first web page. The one or more processors may be configured to receive first user context information that indicates user data associated with the first user device. The one or more processors may be configured to identify, based on the first user interaction information and the first user context information, one or more of first cursor display information or first tooltip display information, wherein the one or more of the first cursor display information or the first tooltip display information indicates at least one user input field. The one or more processors may be configured to transmit the one or more of the first cursor display information or the first tooltip display information. The one or more processors may be configured to receive user feedback information associated with the one or more of the first cursor display information or the first tooltip display information. The one or more processors may be configured to receive second user interaction information associated with a second user device indicating a user interaction with a second web page. The one or more processors may be configured to receive second user context information that indicates user data associated with the second user device. The one or more processors may be configured to identify, based on the user feedback information, the second user interaction information, and the second user context information, one or more of second cursor display information or second tooltip display information. The one or more processors may be configured to transmit the one or more of the second cursor display information or the second tooltip display information.

Some implementations described herein relate to a method of adaptive cursor or tooltip management. The method may include receiving first user interaction information associated with a first user device indicating a user interaction with a first web page. The method may include receiving first user context information that indicates user data associated with the first user device. The method may include identifying, based on the first user interaction information and the first user context information, one or more of first cursor display information or first tooltip display information. The method may include transmitting the one or more of the first cursor display information or the first tooltip display information. The method may include receiving user feedback information associated with the one or more of the first cursor display information or the first tooltip display information. The method may include receiving second user interaction information associated with a second user device indicating a user interaction with a second web page. The method may include receiving second user context information that indicates user data associated with the second user device. The method may include identifying, based on the user feedback information, the second user interaction information, and the second user context information, one or more of second cursor display information or second tooltip display information. The method may include transmitting the one or more of the second cursor display information or the second tooltip display information.

Some implementations described herein relate to a non-transitory computer-readable medium that stores a set of instructions. The set of instructions, when executed by one or more processors of a device, may cause the device to receive first user interaction information associated with a first user device indicating a user interaction with a first web page. The set of instructions, when executed by one or more processors of the device, may cause the device to receive first user context information that indicates user data associated with the first user device. The set of instructions, when executed by one or more processors of the device, may cause the device to identify, based on the first user interaction information and the first user context information, first tooltip display information. The set of instructions, when executed by one or more processors of the device, may cause the device to transmit the first tooltip display information. The set of instructions, when executed by one or more processors of the device, may cause the device to receive user feedback information associated with the first tooltip display information. The set of instructions, when executed by one or more processors of the device, may cause the device to receive second user interaction information associated with a second user device indicating a user interaction with a second web page. The set of instructions, when executed by one or more processors of the device, may cause the device to receive second user context information that indicates user data associated with the second user device. The set of instructions, when executed by one or more processors of the device, may cause the device to identify, based on the user feedback information, the second user interaction information, and the second user context information, one or more of second cursor display information or second tooltip display information. The set of instructions, when executed by one or more processors of the device, may cause the device to transmit the one or more of the second cursor display information or the second tooltip display information.

### BRIEF DESCRIPTION OF THE DRAWINGS

FIGS. 1A-1B are diagrams of an example implementation associated with adaptive cursor or tooltip management, in accordance with some embodiments of the present disclosure.

FIG. 2 is a diagram of an example functional workflow associated with adaptive cursor or tooltip management, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with adaptive cursor or tooltip management, in accordance with some embodiments of the present disclosure.

FIG. 5 is a flowchart of an example process associated with adaptive cursor or tooltip management, in accordance with some embodiments of the present disclosure.

### DETAILED DESCRIPTION

The following detailed description of example implementations refers to the accompanying drawings. The same reference numbers in different drawings may identify the same or similar elements.

A user interface of a user device, such as a user interface provided by a web browser, may include a web page for presentation via the user device. The web page may include hyperlinks to various other web pages in one or more navigational menus. Often, it may be difficult for a user to locate particular information of interest using a navigational menu. For example, descriptions of the navigational menu may be unintuitive and/or the user may need to click through navigational menus in multiple hierarchical levels in order to locate the information of interest. Navigating through a large number of web pages to find relevant information creates a poor user experience, consumes excessive computing resources (e.g., processing resources and memory resources) that are needed for the user device to generate and display the web pages and that are needed for one or more server devices to serve the web pages to the user device, and consumes excessive network resources that are needed for communications between the user device and the server device.

Some implementations described herein enable efficient navigation in a user interface. In some implementations, a universal, context-aware, comprehensive, and adaptive cursor and/or tooltip system integrated with an online platform may help to improve interaction with content of the online platform by modifying a cursor and/or tooltip to provide relevant information based on a user interaction with the user interface and/or user context. For example, the system may dynamically transform the cursor and/or tooltip to provide tools specific to content associated with the user interaction, such as by highlighting important details, previewing certain information, displaying different options, or the like. In some aspects, the system may provide a dynamic, context-sensitive cursor or tooltip interaction tool that adapts in real-time to various content types (e.g., text, images, links, forms, or the like), based on user interactions with the content types within the online platform, and/or based on user context (e.g., browsing behaviors or other information specific to the user). In some examples, the system may employ machine learning techniques to continuously improve a performance of cursor and/or tooltip behaviors and system adaptation over time based on user preferences.

In this way, computing resources and/or network resources may be conserved by reducing an amount of navigation performed by the user. For example, the adapted cursor or tooltip may provide additional information or functionality without requiring users to navigate away from a current view or the web page, or opening new web pages or tabs. For example, the system may reduce excessive clicks and selections that would otherwise consume computing and/or network resources. Furthermore, the techniques described herein make data easier to access by enhancing a user interface, thereby improving user experience, user satisfaction, user interaction, user engagement, and user productivity, and enhancing user-friendliness of a user device and the user interface, and improving the ability of a user to use the user device. For example, the system may offer seamless, intuitive, immediate, and context-sensitive interfaces, functionalities, information, and/or access to relevant tools.

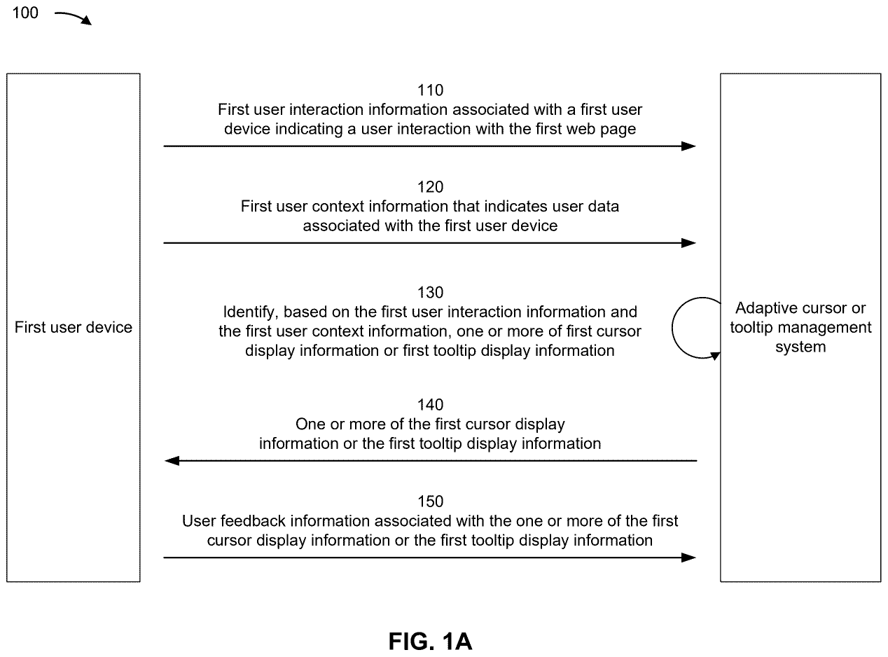

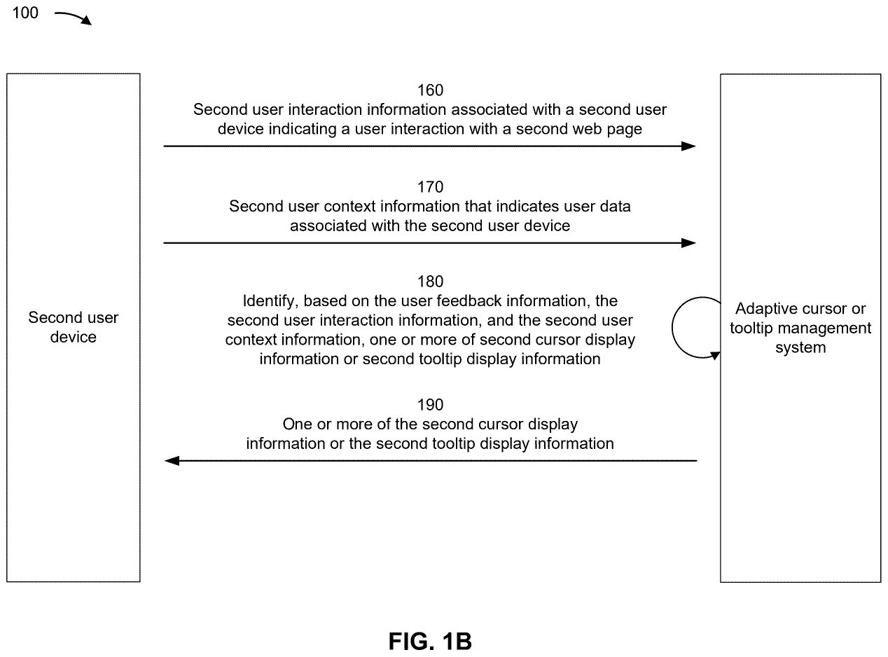

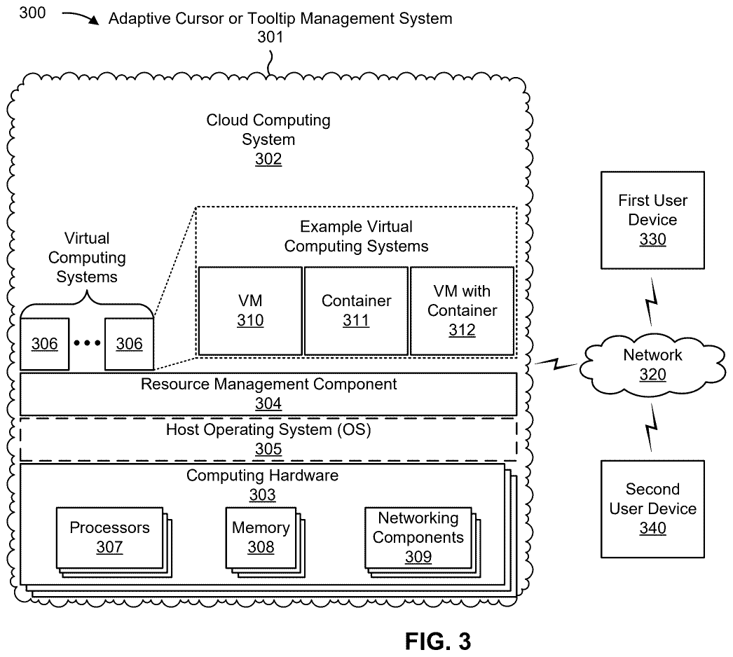

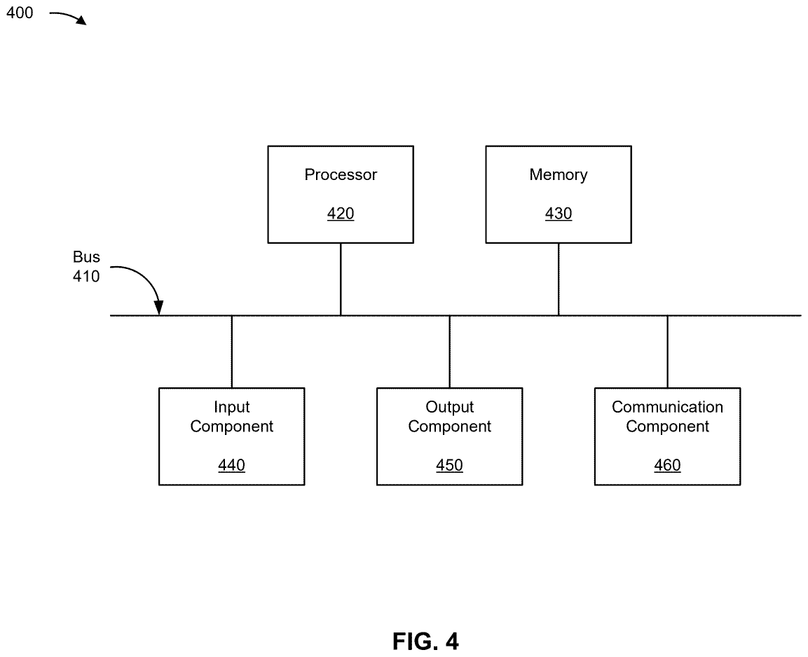

FIGS. 1A-1B are diagrams of an example implementation 100 associated with adaptive cursor or tooltip management. As shown in FIGS. 1A-1B, example implementation 100 includes an adaptive cursor or tooltip management system, a first user device, and a second user device. These devices are described in more detail below in connection with FIG. 3 and FIG. 4.

With reference to FIG. 1A, as shown by reference number 110, the first user device may transmit, and the adaptive cursor or tooltip management system may receive, first user interaction information associated with the first user device indicating a user interaction with a first web page. The first user interaction information may be associated with the first user device in that the first user interaction information may indicate how a user interacts with the first web page via the first user device. In some examples, the user interaction may occur via an input component, such as a mouse, a keyboard, a touchscreen, or the like. The user interaction may include a hover, selection (e.g., click), scroll, or the like.

In some aspects, the first user interaction information may indicate a content type of a display element associated with the user interaction with the first web page. The display element may be displayed on the first web page, and may be associated with the user interaction in that the user interaction involves the display element. For example, the user may cause a cursor to hover over the display element, the user may select (e.g., click on) the display element, the user may scroll over the display element, or the like. The content type may include text, an image, a link, a form, a video, or the like.

As shown by reference number 120, the first user device may transmit, and the adaptive cursor or tooltip management system may receive, first user context information that indicates user data associated with the first user device. The user data may be associated with the first user device in that the user data may relate to the user of the first user device. For example, the user data may include user demographic data, user activity data (e.g., user browsing history, user purchasing history, or the like), or user knowledge data (e.g., indicating how knowledgeable the user is regarding a given topic), among other examples.

As shown by reference number 130, the adaptive cursor or tooltip management system may identify, based on the first user interaction information and the first user context information, one or more of first cursor display information or first tooltip display information. The first cursor display information may include instructions regarding a cursor display at the first user device, and the first tooltip display information may include instructions regarding a tooltip display at the first user device. For example, how the cursor or the tooltip is displayed may depend on how the user interacts with the display element and based on the context regarding the user, such as user demographic data or user activity data. In some aspects, the adaptive cursor or tooltip management system may identify the first cursor display information (e.g., and not the first tooltip display information). In some aspects, the adaptive cursor or tooltip management system may identify the first tooltip display information (e.g., and not the first cursor display information).

In some aspects, the one or more of the first cursor display information or the first tooltip display information may indicate a comparison element corresponding to the display element. For example, the comparison element may compare products or services that are available via the first web page. For example, a user may hover over a display element showing a product or service offering, and the cursor may transform into a comparison tool that enables the user to select multiple products or services for comparison. For example, the cursor may display comparison factors in a pop-up.

In some aspects, the one or more of the first cursor display information or the first tooltip display information may indicate definitional information corresponding to the display element. For example, the definitional information may define one or more terms shown on the first web page. For example, the cursor may provide tooltips with explanations of the term(s).

In some aspects, the one or more of the first cursor display information or the first tooltip display information may indicate supplemental data corresponding to the display element. For example, the supplemental data may indicate information that is not shown in the display element. For example, a user may hover over a name or location of an entity offering a product or service, and the cursor may display a small window that shows ratings, review, and/or contact information of the entity.

In some aspects, the one or more of the first cursor display information or the first tooltip display information may indicate predicted input data corresponding to the display element. For example, the predicted input data may include data that the user is predicted to enter into the first web page. For example, the cursor may offer auto-fill suggestions or validation feedback for entry fields in an interactive form. For example, is a user is entering an address, then the cursor may display a previously entered address and/or common errors to avoid in entering the address.

In some aspects, the one or more of the first cursor display information or the first tooltip display information may indicate at least one user input field. The user input field may include a field in which the user can enter information. For example, the user input field may include product or service fields in the comparison tool described above. Additionally, or alternatively, the user input field may include one or more fields in a calculator, a form, or the like.

As shown by reference number 140, the adaptive cursor or tooltip management system may transmit, and the first user device may receive, the one or more of the first cursor display information or the first tooltip display information. For example, the adaptive cursor or tooltip management system may indicate, to the first user device, how the first user device is to display the cursor and/or the tooltip based on the first user context information and the first user interaction information.

As shown by reference number 150, the first user device may transmit, and the adaptive cursor or tooltip management system may receive, user feedback information associated with the one or more of the first cursor display information or the first tooltip display information. The user feedback information may be associated with the one or more of the first cursor display information or the first tooltip display information in that the user feedback information may indicate a success level of the one or more of the first cursor display information or the first tooltip display information (e.g., how helpful the one or more of the first cursor display information or the first tooltip display information was to the user). In some examples, the user feedback information may indicate implicit feedback, such as whether and/or how long the user interacted with the one or more of the first cursor display information or the first tooltip display information, whether the user navigated to another portion of the first web page, closed the first web page, and/or opened another web page, or the like. In some examples, the user feedback information may indicate explicit feedback, such as a user response to a prompt (e.g., a questionnaire) requesting the user to indicate the success level.

With reference to FIG. 1B, as shown by reference number 160, the second user device may transmit, and the adaptive cursor or tooltip management system may receive, second user interaction information associated with the second user device indicating a user interaction with a second web page. The second user interaction information may be associated with the second user device in that the second user interaction information may indicate how a user interacts with the second web page via the second user device. In some examples, the user interaction may occur via an input component. The input component may be a mouse, a keyboard, a touchscreen, or the like. The user interaction may include a hover, selection (e.g., click), scroll, or the like. The second user interaction information may indicate a content type of a display element associated with the user interaction with the second web page. The display element may be displayed on the second web page, and may be associated with the user interaction in that the user interaction involves the display element. For example, the user may cause a cursor to hover over the display element, the user may select (e.g., click on) the display element, the user may scroll over the display element, or the like. The content type may include text, an image, a link, a form, a video, or the like. The second web page may be the same as, or different from, the first web page. The second user device may be the same as, or different from, the first user device.

As shown by reference number 170, the first user device may transmit, and the adaptive cursor or tooltip management system may receive, second user context information that indicates user data associated with the second user device. The user data may be associated with the second user device in that the user data may relate to the user of the second user device. For example, the user data may include user demographic data, user activity data (e.g., user browsing history, user purchasing history, or the like), or user knowledge data (e.g., indicating how knowledgeable the user is regarding a given topic), among other examples.

As shown by reference number 180, the adaptive cursor or tooltip management system may identify, based on the second user interaction information and the second user context information, one or more of second cursor display information or second tooltip display information. The second cursor display information may include instructions regarding a cursor display at the second user device, and the second tooltip display information may include instructions regarding a tooltip display at the second user device. For example, how the cursor or the tooltip is displayed may depend on how the user interacts with the display element and based on the context regarding the user, such as user demographic data or user activity data. In some aspects, the adaptive cursor or tooltip management system may identify the second cursor display information (e.g., and not the second tooltip display information). In some aspects, the adaptive cursor or tooltip management system may identify the second tooltip display information (e.g., and not the second cursor display information). In some aspects, the one or more of second cursor display information or second tooltip display information may indicate a comparison element corresponding to the display element, definitional information corresponding to the display element, supplemental data corresponding to the display element, or predicted input data corresponding to the display element, and/or at least one user input field (among other examples), as described above in connection with reference number 130.

In some aspects, the adaptive cursor or tooltip management system may identify the one or more of the second cursor display information or second tooltip display information based on the user feedback information. For example, if the user feedback information indicates that the one or more of the first cursor display information or first tooltip display information was unhelpful, then the adaptive cursor or tooltip management system may update the one or more of the second cursor display information or second tooltip display information accordingly (e.g., by providing more, less, or different information in the comparison element, definitional information, supplemental data, predicted input data, or the like). If the user feedback information indicates that the one or more of the first cursor display information or first tooltip display information was helpful, then the adaptive cursor or tooltip management system may refrain from adjusting the one or more of the second cursor display information or second tooltip display information based on the user feedback information, or adjust the one or more of the second cursor display information or second tooltip display information to further enhance helpfulness.

As shown by reference number 190, the adaptive cursor or tooltip management system may transmit, and the first user device may receive, the one or more of the second cursor display information or the second tooltip display information. For example, the adaptive cursor or tooltip management system may indicate, to the second user device, how the second user device is to display the cursor and/or the tooltip based on the second user context information and the second user interaction information.

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

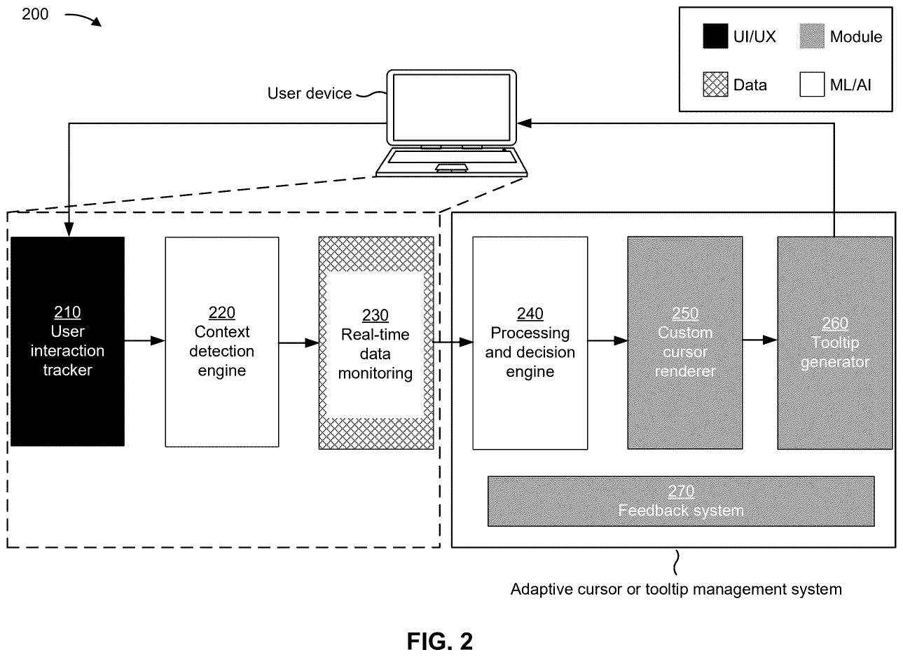

FIG. 2 is a diagram of an example functional workflow 200 associated with adaptive cursor or tooltip management. The functional workflow 200 involves a user device (e.g., the first user device or the second user device) that includes an user interaction tracker 210, a context detection engine 220, and a real-time data monitoring 230, and a back-end system (e.g., the adaptive cursor or tooltip management system), which may include a processing and decision engine 240, a customer cursor renderer 250, a tooltip generator 260, and a feedback system 270.

The user interaction tracker 210 may perform interface design and interaction tracking. For example, the user interaction tracker 210 may track and capture user interaction information (e.g., the first user interaction information or the second user interaction information). For example, the user interaction information may capture real-time user interactions, such as hovering, clicking, and scrolling.

The context detection engine 220 may identify user context information (e.g., the first user context information or the second first user context information). For example, the context detection engine 220 may use one or more machine learning models running directly in a browser to recognize a content type of a display element associated with a user interaction (e.g., text, images, links, forms, or the like). In some examples, the context detection engine 220 may analyze user interactions and predict context in real-time.

The real-time data monitoring 230 may be responsible for real-time monitoring and data transmission. For example, the real-time data monitoring 230 may, on the client side, continuously record user interaction information and/or user context information and transmit this information to the adaptive cursor or tooltip management system. Thus, the real-time data monitoring 230 may capture and respond to user engagement in real-time, providing seamless data transmission for context adaptation.

The processing and decision engine 240 may process user behavior data (e.g., the user interaction information and the user context information) and employ the context detection engine 220 to determine an appropriate cursor adaptation. The processing and decision engine 240 may make real-time decisions regarding cursor transformations based on the user interaction information and the user context information.

The customer cursor renderer 250 may design and apply custom cursors. For example, the customer cursor renderer 250 may dynamically change cursor appearance based on the user interaction information and the user context information. For example, the customer cursor renderer 250 may create and apply various cursor designs (e.g., highlighter for text, magnifying glass for images, or the like). In some examples, the customer cursor renderer 250 may identify cursor display information.

The tooltip generator 260 may create dynamic and interactive tooltips that appear based on cursor interactions. In some examples, the tooltip generator 260 may identify tooltip display information. The feedback system 270 may collect user feedback information and adapt the adaptive cursor or tooltip management system accordingly. For example, the feedback system 270 may gather user feedback and process the user feedback on the server side. For example, the adaptive cursor or tooltip management system may use the feedback system 270 to identify subsequent cursor display information or tooltip display information.

As indicated above, FIG. 2 is provided as an example. Other examples may differ from what is described with regard to FIG. 2.

Identifying cursor display information and/or tooltip display information based on user interaction information and user context information, and/or receiving user feedback information, may help to reduce computing resources and/or network resources by reducing an amount of navigation performed by the user. For example, the cursor display information and/or tooltip display information may provide additional information or functionality without requiring users to navigate away from a current view or web page, or opening new web pages or tabs. For example, the cursor display information and/or tooltip display information may reduce excessive clicks and selections that would otherwise consume computing and/or network resources. Furthermore, the cursor display information and/or tooltip display information may make data easier to access by enhancing a user interface, thereby improving user experience, user satisfaction, user interaction, user engagement, and user productivity, and enhancing user-friendliness of a user device and the user interface, and improving the ability of a user to use the user device. For example, the cursor display information and/or tooltip display information may offer seamless, intuitive, immediate, and context-sensitive interfaces, functionalities, information, and/or access to relevant tools.

FIG. 3 is a diagram of an example environment 300 in which systems and/or methods described herein may be implemented. As shown in FIG. 3, environment 300 may include an adaptive cursor or tooltip management system 301, which may include one or more elements of and/or may execute within a cloud computing system 302. The cloud computing system 302 may include one or more elements 303-312, as described in more detail below. As further shown in FIG. 3, environment 300 may include a network 320, a first user device 330, and/or a second user device 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container management system, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the adaptive cursor or tooltip management system 301 may include one or more elements 303-312 of the cloud computing system 302, may execute within the cloud computing system 302, and/or may be hosted within the cloud computing system 302, in some implementations, the adaptive cursor or tooltip management system 301 may not be cloud-based (e.g., may be implemented outside of a cloud computing system) or may be partially cloud-based. For example, the adaptive cursor or tooltip management system 301 may include one or more devices that are not part of the cloud computing system 302, such as device 400 of FIG. 4, which may include a standalone server or another type of computing device. The adaptive cursor or tooltip management system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The first user device 330 may include one or more devices capable of receiving, generating, storing, processing, and/or providing information associated with adaptive cursor or tooltip management, as described elsewhere herein. The first user device 330 may include a communication device and/or a computing device. For example, the first user device 330 may include a wireless communication device, a mobile phone, a user equipment, a laptop computer, a tablet computer, a desktop computer, or a similar type of device.

The second user device 340 may include one or more devices capable of receiving, generating, storing, processing, and/or providing information associated with adaptive cursor or tooltip management, as described elsewhere herein. The second user device 340 may include a communication device and/or a computing device. For example, the second user device 340 may include a wireless communication device, a mobile phone, a user equipment, a laptop computer, a tablet computer, a desktop computer, or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with adaptive cursor or tooltip management. The device 400 corresponds to one or more of the adaptive cursor or tooltip management system 301, the first user device 330, and/or the second user device 340. In some implementations, the adaptive cursor or tooltip management system 301, the first user device 330, and/or the second user device 340 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

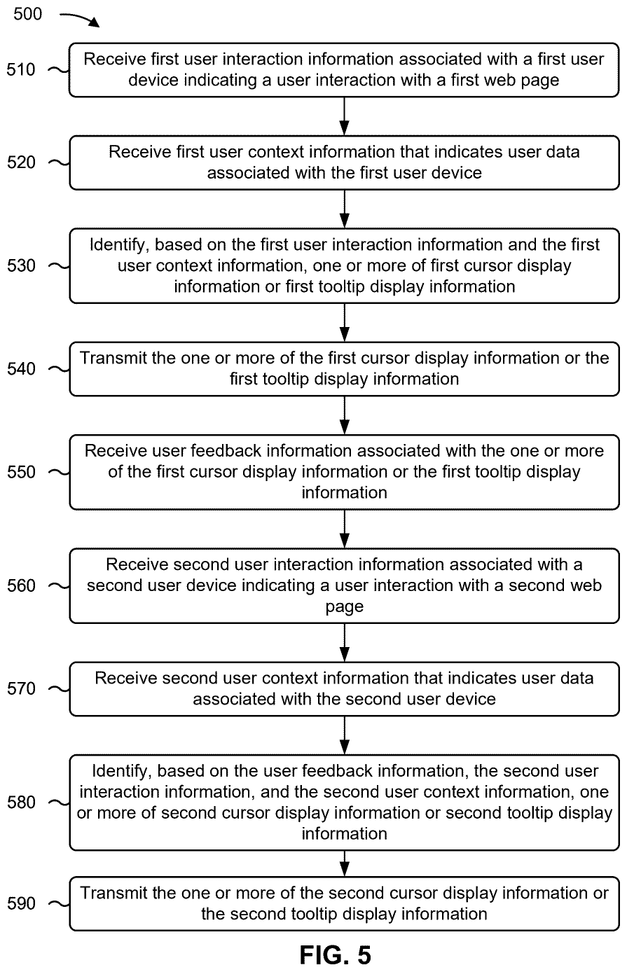

FIG. 5 is a flowchart of an example process 500 associated with adaptive cursor or tooltip management. In some implementations, one or more process blocks of FIG. 5 may be performed by the adaptive cursor or tooltip management system 301. In some implementations, one or more process blocks of FIG. 5 may be performed by another device or a group of devices separate from or including the adaptive cursor or tooltip management system 301, such as the first user device 330 and/or the second user device 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving first user interaction information associated with a first user device indicating a user interaction with a first web page (block 510). For example, the adaptive cursor or tooltip management system 301 (e.g., using processor 420, memory 430, input component 440, and/or communication component 460) may receive first user interaction information associated with a first user device indicating a user interaction with a first web page, as described above in connection with reference number 110 of FIG. 1A. As an example, the first user interaction information may indicate how a user interacts with the first web page via the first user device.

As further shown in FIG. 5, process 500 may include receiving first user context information that indicates user data associated with the first user device (block 520). For example, the adaptive cursor or tooltip management system 301 (e.g., using processor 420, memory 430, input component 440, and/or communication component 460) may receive first user context information that indicates user data associated with the first user device, as described above in connection with reference number 120 of FIG. 1A. As an example, the user data may include user demographic data, user activity data (e.g., user browsing history, user purchasing history, or the like), or user knowledge data (e.g., indicating how knowledgeable the user is regarding a given topic), among other examples.

As further shown in FIG. 5, process 500 may include identifying, based on the first user interaction information and the first user context information, one or more of first cursor display information or first tooltip display information (block 530). For example, the adaptive cursor or tooltip management system 301 (e.g., using processor 420 and/or memory 430) may identify, based on the first user interaction information and the first user context information, one or more of first cursor display information or first tooltip display information, as described above in connection with reference number 130 of FIG. 1A. As an example, the first cursor display information may include instructions regarding a cursor display at the first user device, and the first tooltip display information may include instructions regarding a tooltip display at the first user device.

As further shown in FIG. 5, process 500 may include transmitting the one or more of the first cursor display information or the first tooltip display information (block 540). For example, the adaptive cursor or tooltip management system 301 (e.g., using processor 420, memory 430, and/or communication component 460) may transmit the one or more of the first cursor display information or the first tooltip display information, as described above in connection with reference number 140 of FIG. 1A. As an example, the adaptive cursor or tooltip management system 301 may indicate, to the first user device, how the first user device is to display the cursor and/or the tooltip based on the first user context information and the first user interaction information.

As further shown in FIG. 5, process 500 may include receiving user feedback information associated with the one or more of the first cursor display information or the first tooltip display information (block 550). For example, the adaptive cursor or tooltip management system 301 (e.g., using processor 420, memory 430, input component 440, and/or communication component 460) may receive user feedback information associated with the one or more of the first cursor display information or the first tooltip display information, as described above in connection with reference number 150 of FIG. 1A. As an example, the user feedback information may indicate a success level of the one or more of the first cursor display information or the first tooltip display information (e.g., how helpful the one or more of the first cursor display information or the first tooltip display information was to the user).

As further shown in FIG. 5, process 500 may include receiving second user interaction information associated with a second user device indicating a user interaction with a second web page (block 560). For example, the adaptive cursor or tooltip management system 301 (e.g., using processor 420, memory 430, input component 440, and/or communication component 460) may receive second user interaction information associated with a second user device indicating a user interaction with a second web page, as described above in connection with reference number 160 of FIG. 1B. As an example, the second user interaction information may indicate how a user interacts with the second web page via the second user device.

As further shown in FIG. 5, process 500 may include receiving second user context information that indicates user data associated with the second user device (block 570). For example, the adaptive cursor or tooltip management system 301 (e.g., using processor 420, memory 430, input component 440, and/or communication component 460) may receive second user context information that indicates user data associated with the second user device, as described above in connection with reference number 170 of FIG. 1B. As an example, the user data may include user demographic data, user activity data (e.g., user browsing history, user purchasing history, or the like), or user knowledge data (e.g., indicating how knowledgeable the user is regarding a given topic), among other examples.

As further shown in FIG. 5, process 500 may include identifying, based on the user feedback information, the second user interaction information, and the second user context information, one or more of second cursor display information or second tooltip display information (block 580). For example, the adaptive cursor or tooltip management system 301 (e.g., using processor 420 and/or memory 430) may identify, based on the user feedback information, the second user interaction information, and the second user context information, one or more of second cursor display information or second tooltip display information, as described above in connection with reference number 180 of FIG. 1B. As an example, the second cursor display information may include instructions regarding a cursor display at the second user device, and the second tooltip display information may include instructions regarding a tooltip display at the second user device.

As further shown in FIG. 5, process 500 may include transmitting the one or more of the second cursor display information or the second tooltip display information (block 590). For example, the adaptive cursor or tooltip management system 301 (e.g., using processor 420, memory 430, and/or communication component 460) may transmit the one or more of the second cursor display information or the second tooltip display information, as described above in connection with reference number 190 of FIG. 1B. As an example, the adaptive cursor or tooltip management system may indicate, to the second user device, how the second user device is to display the cursor and/or the tooltip based on the second user context information and the second user interaction information.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A, 1B, and 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for adaptive cursor or tooltip management, the system comprising:
one or more memories; and
one or more processors, communicatively coupled to the one or more memories, configured to:
receive first user interaction information associated with a first user device indicating a user interaction with a first web page;
receive first user context information that indicates user data associated with the first user device;
identify, based on the first user interaction information and the first user context information, one or more of first cursor display information or first tooltip display information, wherein the one or more of the first cursor display information or the first tooltip display information indicates at least one user input field;
transmit the one or more of the first cursor display information or the first tooltip display information;
receive user feedback information associated with the one or more of the first cursor display information or the first tooltip display information;
receive second user interaction information associated with a second user device indicating a user interaction with a second web page;
receive second user context information that indicates user data associated with the second user device;
identify, based on the user feedback information, the second user interaction information, and the second user context information, one or more of second cursor display information or second tooltip display information; and
transmit the one or more of the second cursor display information or the second tooltip display information.

2. The system of claim 1, wherein the first user interaction information indicates a content type of a display element associated with the user interaction with the first web page.

3. The system of claim 1, wherein the one or more of the first cursor display information or the first tooltip display information indicates a comparison element corresponding to a display element associated with the user interaction with the first web page.

4. The system of claim 1, wherein the one or more of the first cursor display information or the first tooltip display information indicates definitional information corresponding to a display element associated with the user interaction with the first web page.

5. The system of claim 1, wherein the one or more of the first cursor display information or the first tooltip display information indicates supplemental data corresponding to a display element associated with the user interaction with the first web page.

6. The system of claim 1, wherein the one or more of the first cursor display information or the first tooltip display information indicates predicted input data corresponding to a display element associated with the user interaction with the first web page.

7. The system of claim 1, wherein the one or more of the first cursor display information or the first tooltip display information includes the first cursor display information.

8. The system of claim 1, wherein the one or more of the first cursor display information or the first tooltip display information includes the first tooltip display information.

9. A method of adaptive cursor or tooltip management, comprising:
receiving first user interaction information associated with a first user device indicating a user interaction with a first web page;
receiving first user context information that indicates user data associated with the first user device;
identifying, based on the first user interaction information and the first user context information, one or more of first cursor display information or first tooltip display information;
transmitting the one or more of the first cursor display information or the first tooltip display information;
receiving user feedback information associated with the one or more of the first cursor display information or the first tooltip display information;
receiving second user interaction information associated with a second user device indicating a user interaction with a second web page;
receiving second user context information that indicates user data associated with the second user device;
identifying, based on the user feedback information, the second user interaction information, and the second user context information, one or more of second cursor display information or second tooltip display information; and
transmitting the one or more of the second cursor display information or the second tooltip display information.

10. The method of claim 9, wherein the first user interaction information indicates a content type of a display element associated with the user interaction with the first web page.

11. The method of claim 9, wherein the one or more of the first cursor display information or the first tooltip display information indicates a comparison element corresponding to a display element associated with the user interaction with the first web page.

12. The method of claim 9, wherein the one or more of the first cursor display information or the first tooltip display information indicates definitional information corresponding to a display element associated with the user interaction with the first web page.

13. The method of claim 9, wherein the one or more of the first cursor display information or the first tooltip display information indicates supplemental data corresponding to a display element associated with the user interaction with the first web page.

14. The method of claim 9, wherein the one or more of the first cursor display information or the first tooltip display information indicates predicted input data corresponding to a display element associated with the user interaction with the first web page.

15. The method of claim 9, wherein the one or more of the first cursor display information or the first tooltip display information indicates at least one user input field.

16. The method of claim 9, wherein the one or more of the first cursor display information or the first tooltip display information includes the first cursor display information.

17. The method of claim 9, wherein the one or more of the first cursor display information or the first tooltip display information includes the first tooltip display information.

18. A non-transitory computer-readable medium storing a set of instructions, the set of instructions comprising:
one or more instructions that, when executed by one or more processors of a device, cause the device to:
receive first user interaction information associated with a first user device indicating a user interaction with a first web page;
receive first user context information that indicates user data associated with the first user device;
identify, based on the first user interaction information and the first user context information, first tooltip display information;
transmit the first tooltip display information;
receive user feedback information associated with the first tooltip display information;
receive second user interaction information associated with a second user device indicating a user interaction with a second web page;
receive second user context information that indicates user data associated with the second user device;
identify, based on the user feedback information, the second user interaction information, and the second user context information, one or more of second cursor display information or second tooltip display information; and
transmit the one or more of the second cursor display information or the second tooltip display information.

19. The non-transitory computer-readable medium of claim 18, wherein the first user interaction information indicates a content type of a display element associated with the user interaction with the first web page.

20. The non-transitory computer-readable medium of claim 18, wherein the first tooltip display information indicates an element that includes at least one input field.
